(19) United States
(12) Patent Application Publication
(10) Pub. No.: US 2026/0359657 A1
(43) Pub. Date: Nov. 12, 2026

(54) MERGING ADVERSARIALLY-ROBUST NEURAL NETWORKS

(71) Applicant: DeepMind Technologies Limited, London (GB)

(72) Inventors: Francesco Croce, London (GB); Sylvestre-Alvise Guglielmo Rebuffi, Sceaux (FR); Sven Adrian Gowal, Cambridge (GB); Evan Gerard Shelhamer, London (GB)

(21) Appl. No.: 19/129,158

(22) PCT Filed: Nov. 13, 2023
(86) PCT No.: PCT/EP2023/081621

§ 371 Date: May 12, 2025

Related U.S. Application Data
(60) Provisional application No. 63/424,770, filed on Nov. 11, 2022.

(51) Int. Cl. G06N 3/094

(52) U.S. Cl. CPC G06N 3/094

(57) ABSTRACT

Methods, systems, and apparatus, including computer programs encoded on computer storage media, for merging adversarially-robust neural networks.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a neural network to be resistant to adversarial attacks. That is, the system generates, by training the neural network, final values for the parameters of the neural network (“network parameters”) that will be used to perform a target task.

Particular embodiments of the subject matter described in this specification can be implemented so as to realize one or more of the following advantages.

By training a neural network as described in this specification, the neural network becomes more secure by virtue of being less susceptible to adversarial attacks. An adversarial attack occurs when a malicious attacker intentionally submits inputs to the neural network that cause undesired behavior, i.e., incorrect outputs to be generated by the neural network. Thus, the security of the computer system that includes the neural network is improved because the system becomes more resistant to these types of attacks.

Conventional techniques for training neural networks to be more robust to multiple adversarial threats, i.e., to multiple different types of adversarial attack, require knowledge of these threats during training and remain vulnerable to unseen threats. The described techniques, however, generate the final parameter values for the neural network by “merging” parameter values for multiple different neural networks trained using multiple different adversarial training schemes. In so doing, the final neural network smoothly trades-off robustness to different adversaries by modifying how the parameter values are combined and without any additional training. Moreover, the final neural network can achieve robustness to all threats in an entire set of threads without jointly training on all of them, thereby reducing training time. In some cases, the resulting neural network is more robust to a given adversary than the constituent model specialized against that same adversary. Thus, the resulting neural network is significantly more robust to a range of adversarial attack than models trained using conventional techniques and can generalize to be robust to attacks that were unknown at training time.

Additionally, by generating the final parameter values using the described techniques, the neural network can generalize to inference time and test time inputs that have a “distribution shift” relative to the training inputs used to train the neural network, improving the performance of the neural network on a variety of real-world tasks where distribution shift may be likely and without requiring any re-training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example training system.

FIG. 1B shows an example configuration system.

FIG. 2 is a flow diagram of an example process for merging adversarially-robust neural networks.

FIG. 3 is a flow diagram of an example process for training the instances of the neural network.

FIG. 4 is a flow diagram for configuring the neural network after training.

FIG. 5 shows an example of the results achieved by making use of the described techniques on eight different image classification tasks.

FIG. 6 shows an example of robust accuracy of the described techniques for various weights.

Like reference numbers and designations in the various drawings indicate like elements.

### DETAILED DESCRIPTION

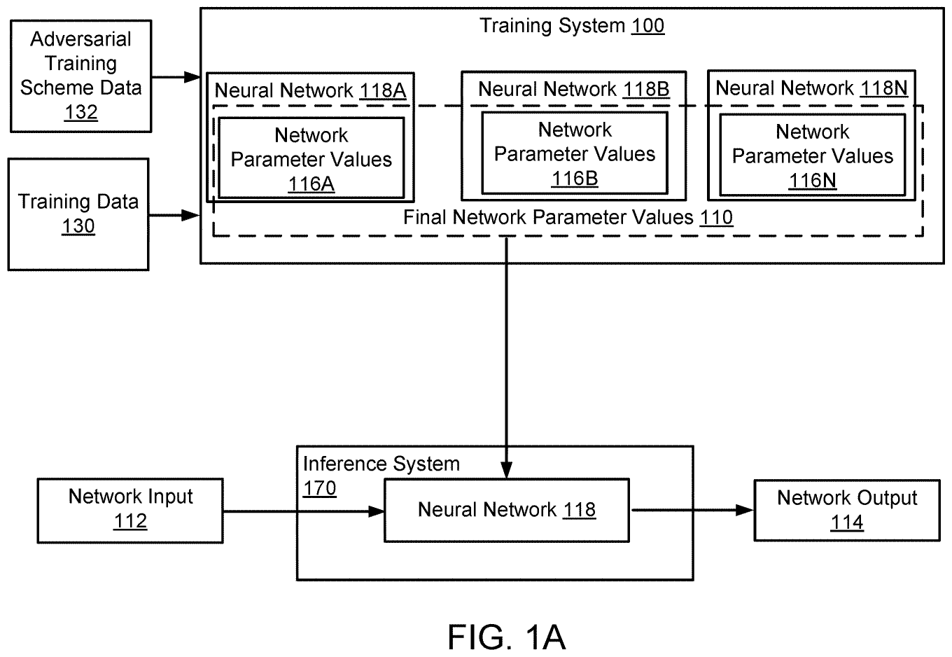

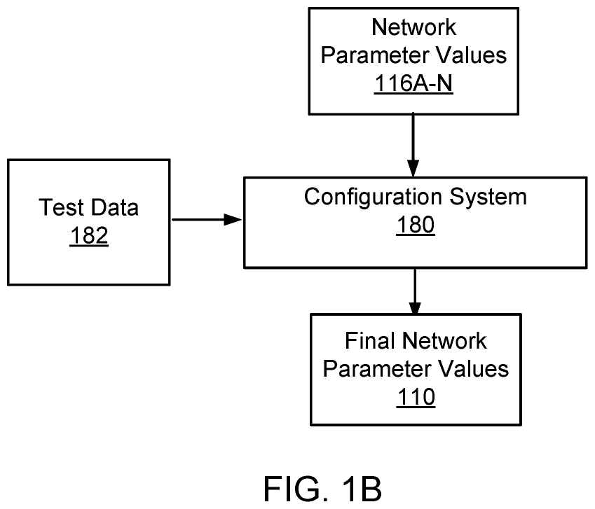

FIG. 1A shows an example training system 100. The training system 100 is an example of a system implemented as computer programs on one or more computers in one or more locations, in which the systems, components, and techniques described below can be implemented.

The system 100 trains a neural network 118 to be resistant to adversarial attacks. That is, the system 100 generates, by training the neural network 118, final values 110 for the parameters of the neural network 118 (“network parameters”) that will be used to perform a target task.

An “adversarial attack” occurs when a small change, e.g., an imperceptible change, to a network input to the neural network 118 is made in an attempt to cause the neural network 118 to generate a different output for the perturbed input than would be generated for the original network input. Such changes are also referred as “adversarial perturbations.” That is, because the perturbation applied to the original network input is small, if the trained neural network 118 is robust, the perturbation should not cause a change in the predicted output. However, many trained neural networks can be brittle and can perform poorly under distribution shift, i.e., perform poorly when inference-time inputs are drawn from a distribution that differs from the distribution of training inputs. As a result, these adversarial perturbations can (undesirably) cause changes in the outputs generated by the neural network.

By training the neural network 118 to be resistant to adversarial attacks, the system 100 obtains final values 110 of the network parameters that cause the neural network 118 to have robust, rather than brittle, performance at inference time, i.e., when processing network inputs 112 to generate network outputs 114 for the target task after training.

In particular, the described techniques can be used to train a neural network 118 to perform any task that requires receiving continuous inputs, i.e., inputs that can take any value from some predetermined range.

For example, if the inputs to the neural network 118 are images, i.e., the intensity values of the pixels of the images, the output generated by the neural network 118 for a given image may be an image classification output that includes scores for each of a set of object categories, with each score representing an estimated likelihood that the image contains an image of an object belonging to the category.

As another example, if the inputs to the neural network 118 are images, the output generated by the neural network 118 for a given image may be an objection detection output that identifies positions of objects within the given image.

As another example, if the inputs to the neural network 118 are images, the output generated by the neural network 118 for a given image may be an image segmentation output that identifies, for each pixel of the given input image, a category from a set of possible categories that the scene depicted at the pixel belongs to.

As another example, if the inputs to the neural network 118 are sensor data characterizing a state of an environment being interacted with by an agent, e.g., image data, position data, or other sensor data captured by sensors of a robot or other agent, the output generated by the neural network data can be a control policy for controlling the agent, e.g., data defining a probability distribution over possible actions that can be performed by the agent. The environment may be a real world environment, and the agent may be a physical agent operating in the real world environment. As particular examples, the sensor data can be data from an image, distance, or position sensor or from an actuator. For example in the case of a robot, the sensor data may include data characterizing the current state of the robot, e.g., one or more of: joint position, joint velocity, joint force, torque or acceleration, e.g., gravity-compensated torque feedback, and global or relative pose of an item held by the robot. The sensor data may also include, for example, sensed electronic signals such as motor current or a temperature signal; and/or image or video data for example from a camera or a LIDAR sensor, e.g., data from sensors of the agent or data from sensors that are located separately from the agent in the environment.

The neural network 118 can have any appropriate architecture that allows the neural network 118 to perform the target task, i.e., to map network inputs of the type and dimensions required by the task to network outputs of the type and dimensions required by the task. That is, when the task is a classification task, the neural network 118 maps the input to the classification task to a set of scores, one for each possible class for the task. When the task is a regression task, the neural network 118 maps the input to the regression task to a set of regressed values, one for each value that needs to be generated in order to perform the regression task.

As one example, when the inputs are images, the neural network 118 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the neural network 118 can be a recurrent neural network, e.g., a long short-term memory (LSTM) or gated recurrent unit (GRU) based neural network, or a Transformer neural network.

As another example, the neural network 118 can be feed-forward neural network, e.g., an MLP, that includes multiple fully-connected layers.

Generally, the system obtains data specifying a plurality of different adversarial training schemes 132.

Each adversarial training scheme 132 trains the neural network 118 to be robust to a different type of adversarial attack.

For example, each adversarial training scheme 132 can have a different corresponding adversarial training loss function.

As a particular example, some or all of the adversarial training schemes can train the neural network 118 to be robust to Iₚ-norm bounded perturbations for different values of p.

In particular, in this example, each of these adversarial training schemes is associated with a corresponding function A that characterizes a corresponding threat model for the adversarial training scheme and that maps an input x to a set of A (x) of possible perturbed versions of the input x. For example, Iₚ-norm bounded perturbations with budget ∈>0 can be described by:

Δ(x)={δ∈ [symbol] ^{d}:∥δ∥ₚ≤∈,x+δ∈[0,1]^{d}},

where d is the number of elements in the input x and ∥δ∥ₚ, is the Iₚ-norm of δ.

As a particular example, the possible values of p can include two or more of: 1, 2, or infinity.

Given a set of training data D, the adversarial training loss function that is associated with a given value of p can satisfy:

$${min}_{θ} {\sum }_{( x , y ) ∈ D} {max}_{δ ∈ Δ ( x )} L ( f ( θ , x + δ ) , y ) ) ,$$

where y is the target (“ground truth”) output for the input x, θ are the values of the network parameters, f(θ, x+δ) is the network output generated by the neural network for the perturbed input x+δ given θ and L is a loss function for the target task, e.g., a cross-entropy loss function or other appropriate loss function.

In some implementations, the set of adversarial training schemes 132 can also include a “nominal” scheme that does not apply any perturbation to the training inputs and simply trains using the loss function L.

While the above describes the plurality of adversarial training schemes including Iₚ-norm based schemes, other adversarial training schemes can also be included in the set of schemes 132. For example, the plurality of adversarial training schemes can include one or more schemes that have a corresponding loss function that has a regularizer that encourages the loss to behave linearly in the vicinity of the training data. One example of such a technique is described in Qin, et al, Advesarial Robustness through Local Linearization, arXiv:1907.02610.

For each of the plurality of adversarial training schemes, the system 100 trains an instance 118A-N of the neural network on a respective set of training data for the target task (with different schemes optionally having different respective sets of training data) using the adversarial training scheme to determine respective trained values 116A-N for each of the plurality of network parameters. For example, each set of training data can be a respective subset of a larger set of training data 130 for the target task or can include a respective number of epochs of training on the set of training data 130.

In some implementations, the system 100 trains each instance 118A-118N of the neural network from scratch, e.g., on the entire larger set of training data 130.

In some other implementations, however, the system 100 first trains one instance (“a first instance”) of the neural network from scratch or from a pre-trained checkpoint and then fine-tunes one or more of the other instances from the parameter values determined by training the first instance.

Training the instances 118A-N of the neural network is described in more detail below.

As a result of training the instances 118A-N, the system 100 obtains respective trained values 116A-N of the network parameters for each instance 118A-N and, therefore, respective trained values 116A-N of the network parameters corresponding to each of the adversarial training schemes.

While a given trained instance 118A-N may be robust to the corresponding type of adversarial attack, at inference time, the neural network 118 may be exposed to many different types of adversarial attacks, including ones that do not correspond to any of the adversarial training schemes 132. As a result, any single one of the trained instances 118A-N may not be robust enough to all types of adversarial attack to be used for performing inference. Moreover, inputs at inference time can have a “distribution shift” relative to the training inputs in the training data 130. As a result, the trained instances 118A-N may perform poorly at inference time when such a distribution shift exists.

For example, for a task that requires processing images, e.g., image classification or object detection or another computer vision task, distribution shift may occur when inference-time images are drawn from a distribution that differs from the distribution of training images. For example, the neural network may be trained on images of one real-world region and the inference images may be images of another region that is similar to the real-world region but has different properties, e.g., different objects, different lighting conditions, and so on. As another example, the neural network may be trained on images of one real-world region and the inference images may be images of the same real-world region but under different imaging conditions, e.g., different weather or lighting or other conditions. As another example, when the image are medical images, the training images may be images of one set of patients and the inference images may be images of another set of patients that has different characteristics from the training set.

For example, for a task that requires controlling an agent, distribution shift may occur when inference-time “observations” of the environment are drawn from a distribution that differs from the distribution of training “observations” of the environment. For example, the neural network may be trained on observations of one real-world environment and the inference observations may be observations of another environment region that includes different objects or that otherwise differs from the training region. As another example, the neural network may be trained on observations of a simulated environment and the inference observations may be observations of a real-world environment that is being simulated by the simulated environment. As yet another example, the neural network may be trained on observations generated by one set of sensors and the inference observations may be observations captured by a different set of sensors that, e.g., generate noisy sensor readings or that otherwise differ from the training sensors.

To account for this, the training system 100 (or the inference system 170) “merges” the parameter values for the multiple different instances trained using the multiple different adversarial training schemes. In so doing, the final neural network 118 smoothly trades-off robustness to different adversaries by modifying how the parameter values are combined and without any additional training. Moreover, the final neural network 118 can achieve robustness to many different threats without jointly training on all of them, thereby reducing training time. In some cases, the resulting neural network 118 is more robust to a given adversary than the constituent instance specialized against that same adversary. Thus, the resulting neural network 118 is significantly more robust to a range of adversarial attack than models trained using conventional techniques and can generalize to be robust to attacks that were unknown at training time.

Additionally, by generating the final parameter values by “merging” the parameter values of the trained instances, the neural network 118 can generalize to inference time and test time inputs that have a “distribution shift” relative to the training inputs used to train the neural network, improving the performance of the neural network 118 on a variety of real-world tasks where distribution shift may be likely and without requiring any re-training.

In particular, to perform the “merging,” for each of the plurality of network parameters, the system 100 or the inference system 170 generates a final value 110 for the network parameter by combining the respective trained values 116A-N for the network parameter for each of the plurality of adversarial training schemes. Thus, the final values 110 are a “merged” version of the trained values 116A-N.

Merging the parameter values is described in more detail below.

After determining the final values 110, the system 100 or the inference system 170 then uses the neural network 118 in accordance with the final values 110 of the network parameters to perform the target task on new network inputs 112, provides the final values to another system for use in performing the target task on new network inputs, or both.

FIG. 1B shows an example configuration system 180. The configuration system 180 can be implemented as part of the training system 100 or the inference system 170 of FIG. 1A.

Generally, each time that the neural network 118 needs to be deployed for processing inference data in an environment that may exhibit distribution shift relative to an environment where the neural network 118 was previously deployed, each time that robustness to a new type of adversarial attack is required, or both, the configuration system 180 can determine new final network parameter values 110 to be used by the neural network 118 at deployment time without needing to retrain any of the instances 118A-N of the neural network 118.

In particular, the configuration system 180 receives the trained network parameter values 116A-N for the instances 118A-N, e.g., generated as described above.

The configuration system 180 also receives test data for the target task. Generally, the test data includes test examples that match the likely distribution of the inference inputs that will be processed by the neural network 118 after the neural network 118 has been deployed. In some cases, the system 180 can obtain the test data 182 after the neural network 118 has already been deployed in a given environment, e.g., as a result of monitoring the inference inputs and determining that the final network parameters 110 need to be updated.

The configuration system 180 uses the test data 182 and the trained network parameter values 116A-N to determine new final values 110 for the network parameters, i.e., to determine final values 110 that adapt the test data to the distribution represented by the test data 182, without retraining the neural network 118.

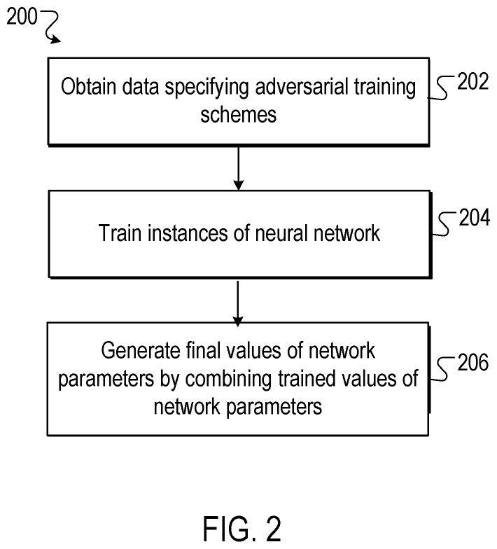

Determining the new final values 110 is described in more detail below with reference to FIGS. 2-4.

The inference system 170 or another system can then use the neural network 118 to perform inference in accordance with the new final values 110.

FIG. 2 is a flow diagram of an example process 200 for training a neural network to be robust to adversarial attack. For convenience, the process 200 will be described as being performed by a system of one or more computers located in one or more locations. For example, a training system, e.g., the training system 100 of FIG. 1A, appropriately programmed, can perform the process 200.

The system obtains data specifying a plurality of adversarial training schemes obtaining data specifying a plurality of different adversarial training schemes (step 202). As described above, each adversarial training scheme trains the neural network to be robust to a different type of adversarial attack.

For example, for two or more of the adversarial training schemes, the type of adversarial attack for the adversarial training scheme can be an/p-norm bounded attack for a corresponding value of p, with each of the two or more of the adversarial training schemes have different corresponding values of p. As described above, the value of p can define the adversarial training loss function used to train the neural network under the adversarial training scheme.

For each of the plurality of adversarial training schemes, the system trains an instance of the neural network on a respective set of training data for the target task using the adversarial training scheme to determine respective trained values for each of the plurality of network parameters (step 204).

As described above, each adversarial training scheme will generally be associated with a different adversarial training loss function from each other adversarial training scheme. To train an instance of the neural network using a given adversarial training scheme, the system trains the instance of the neural network on the loss function corresponding to the adversarial training scheme, e.g., using an appropriate machine learning technique, e.g., a gradient-based technique with an appropriate optimizer, e.g., Adam, rmsProp, SGD, and so on.

In some implementations, the system trains each of the instances independently, e.g., so that each instance is trained on the same set of training data, starting from randomly initialized values of the network parameters or from pre-trained values of the network parameters as generated by pre-training the neural network, e.g., by a different training system or using a different training objective.

In some other implementations, to improve the computational efficiency of the training process, the system first trains the instance of the neural network using one adversarial training scheme and then uses the trained instance to “bootstrap” the training of the other instances using the other adversarial training schemes.

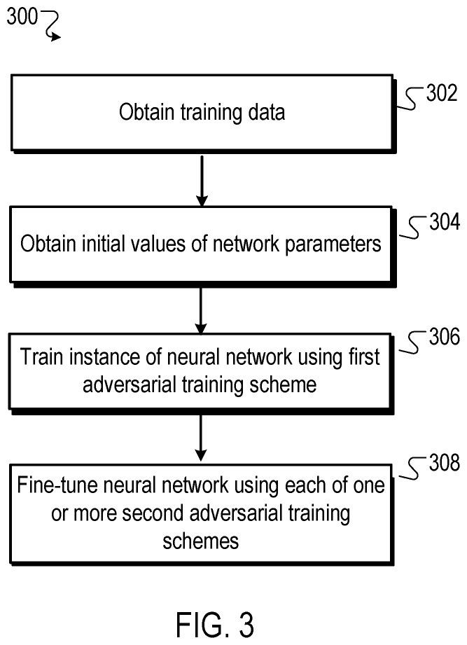

This is described in more detail below with reference to FIG. 3.

After training the instances and for each of the plurality of network parameters, the system generates a final value for the network parameter by combining the respective trained values for the network parameter for each of the plurality of adversarial training schemes (step 206).

Generally, the system combines the respective trained values so that the resulting neural network, i.e., that uses the final values of the network parameters, will have improved performance on the target task relative to any one of the trained instances.

For example, the system can determine a respective weight for each of the adversarial training schemes. The system can then, for each of the plurality of network parameters, compute a weighted sum of the respective trained values for the network parameter for each of the plurality of adversarial training schemes in accordance with the respective weights for each of the adversarial training schemes.

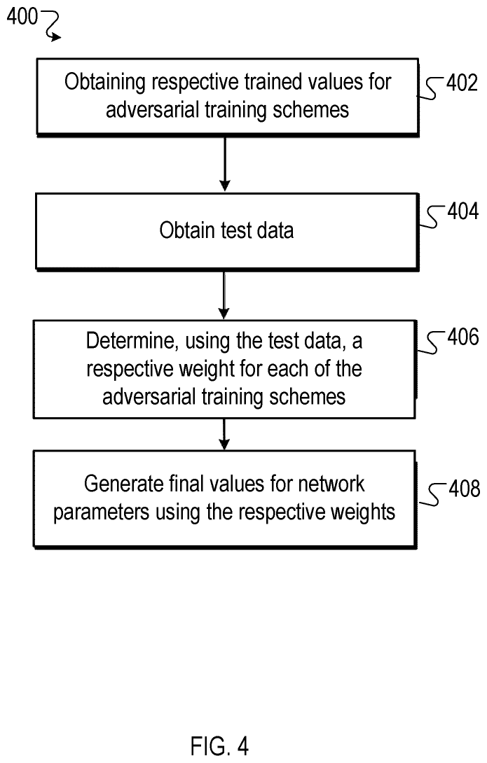

One example technique for determining the respective weights is described in more detail below with reference to FIG. 4.

After determining the final values of the network parameters, the system can use the final values to perform inference or can provide the final values to another system for use in performing inference. That is, the system (or the other system) can receive a new network input for the target task and then process the new network input using the neural network and in accordance with the final values of the network parameters, i.e., with the network parameters set to the final values, to generate network output for a target task for the new network input.

FIG. 3 is a flow diagram of an example process 300 for training the instances of the neural network. For convenience, the process 300 will be described as being performed by a system of one or more computers located in one or more locations. For example, a training system, e.g., the training system 100 of FIG. 1A, appropriately programmed, can perform the process 300.

The system obtains a set of training data for the target task (step 302). The set of training data generally includes multiple training examples, with each training example including a training input and a corresponding target output for the training input, i.e., the output that should be generated by performing the target task on the training input.

The system also obtains initial values of the network parameters of the neural network (step 304).

For example, the system can initialize the initial values using a random parameter initialization technique, e.g., Glorot initialization, He initialization, or another parameter initialization technique.

As another example, the neural network can have been pre-trained, e.g., through unsupervised learning or on another task, and the system can set the initial values equal to the pre-trained values.

The system trains an instance of the neural network on the set of training data for the target task using a first adversarial training scheme (of the multiple adversarial training schemes) and starting from the initial values of the network parameters to determine respective trained values for each of the plurality of network parameters (step 306).

For example, the system can select the first scheme at random from the set of multiple schemes. As another example, the system can receive an input identifying which scheme in the set of multiple schemes should be the first scheme.

For each of one or more of the other schemes (“second schemes”), the system trains an instance of the neural network on a corresponding set of training data for the target task using the second adversarial training scheme and starting from the respective trained values of the network parameters for the first adversarial training scheme to determine respective trained values for each of the plurality of network parameters (step 304).

That is, the system “fine-tunes” the instance of the neural network corresponding to the first scheme using the second scheme and starting from the trained values of the instance of the neural network corresponding to the first scheme, i.e., rather than from the randomly initialized or pre-trained values that were used at the beginning of the training of the instance of the neural network corresponding to the first scheme.

Generally, when training the instance of the neural network using the second adversarial training scheme, the system trains the instance of the neural network for (i) fewer training iterations, (ii) on fewer training examples, or both than were used in the training for the first adversarial training scheme. For example, the system can train each second instance for only one epoch or, more generally, fewer than five epochs while training the first instance for at least ten epochs.

Thus, the system can reduce the amount of computational resources consumed by training the network instances by only training the first instance from scratch and then “fine-tuning” the other instances on fewer training examples.

As a particular example, instead of training each instance for ten training epochs, when there are three total instances, the system can train the first instance for ten training epochs, while training each of the other two instances for only three epochs starting from the trained values of the first instance. Thus, rather than training for thirty total epochs, the system achieves comparable performance but only trains for sixteen total epochs. Because training large neural networks is computationally expensive, the system makes the training significantly more computationally efficient while still obtaining instances that are high-performing with respect to their corresponding type of adversarial attack.

FIG. 4 is a flow diagram of an example process 400 for determining the final values of the network parameters. For convenience, the process 400 will be described as being performed by a system of one or more computers located in one or more locations. For example, a training system, e.g., the training system 100 of FIG. 1A, or an inference system, e.g., the inference system 170 of FIG. 1A, appropriately programmed, can perform the process 400.

The system obtains respective trained values of the network parameters for each of the multiple adversarial training schemes (step 402), e.g., as determined by performing the training described above with reference to FIGS. 2 and 3.

The system obtains test data for the target task (step 404). For example, the distribution of the network inputs in the test data can differ from a distribution of network inputs in the respective sets of training data for the adversarial training schemes.

The system determines, using the test data, a respective weight for each of the adversarial training schemes (step 406).

The system can use the test data to determine the weights for each of the adversarial training schemes in any of a variety of ways.

As one example, the system can determine a plurality of candidate sets of weights, and for each of the plurality of candidate sets of weights, generate, using the candidate set of weights, respective candidate final parameter values for the network parameters.

The system can determine a performance metric on the test data of an instance of the neural network having the candidate final parameter values and selecting one of the candidate sets of weights based on the performance metrics, e.g., by selecting the candidate set of weights that has the best performance metric.

For example, the performance metric can measure an accuracy on the test data of the instance of the neural network having the candidate final parameter values. Thus, the system can use the test data to adapt the neural network to perform better on inputs having the distribution reflected by the test data.

As another example, the performance metric can measure a robustness of the instance of the neural network having the candidate final parameter values to one or more particular types of adversarial attack on network inputs in the test data. In this example, one or more of the particular types of adversarial attack are different from the type of adversarial attack for any of the plurality of adversarial training schemes. Thus, the system can use the test data to adapt the neural network to perform better on one or more new types of adversarial attacks that were not encountered during.

The system can determine the candidate sets of weights using any appropriate type of technique for searching through the space of possible sets of weights, e.g., grid search, random search, evolutionary search, gradient-descent based search, and so on.

The system generates final values for the network parameters using the respective weights (step 408).

In particular, for each of the plurality of network parameters, the system generates a final value for the network parameter by computing a weighted sum of the respective trained values for the network parameter for each of the plurality of adversarial training schemes in accordance with the respective weights for the adversarial training schemes.

Thus, the system adapts the neural network to the test data without requiring any additional training, i.e., by only using the test data to compute new weights for the adversarial training schemes. Thus, the system can adapt the same neural network for processing differently distributed inference inputs without any additional training.

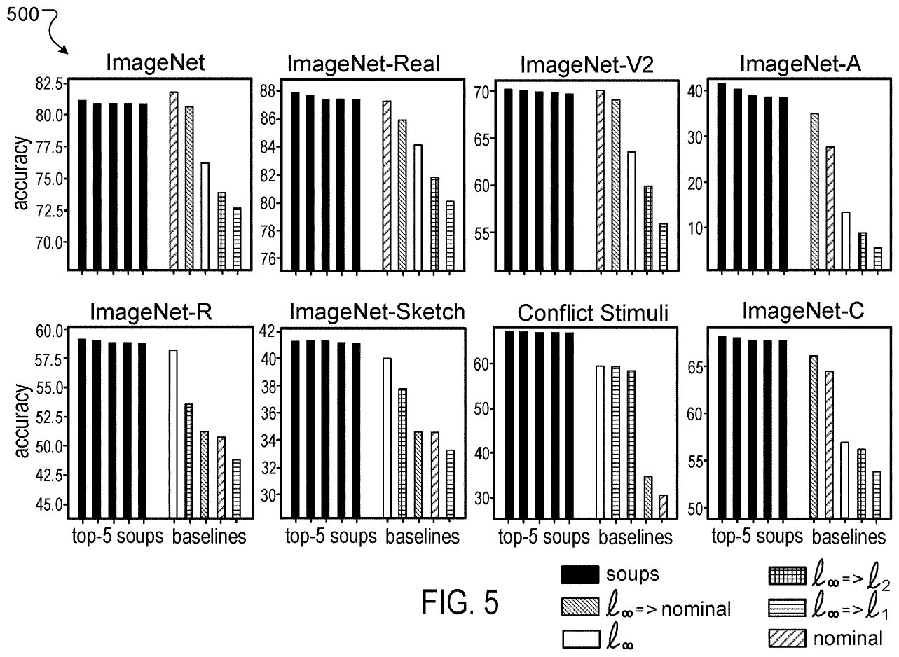

FIG. 5 shows an example 500 of the results achieved by making use of the described techniques on eight different image classification tasks.

In particular, for each of the eight tasks, the example 500 shows the performance of the best 5 final values (“soups”) generated by combining the trained values for four different instances of the neural network relative to the four individual instances and to a “nominal” model that has been independently trained.

As can be seen from FIG. 5, the soups are at least comparable to the baselines on each of the tasks and, for some of the tasks, show significant improvement in accuracy without requiring any additional training relative to any of the baselines. Moreover, in addition to the improved accuracy shown in FIG. 5, the soups are significantly more robust to a wide-range of adversarial attacks relative to any of the baselines.

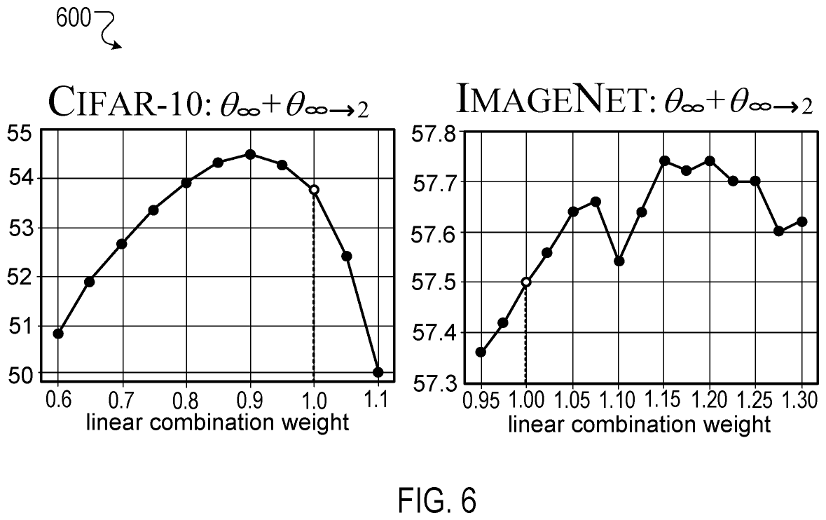

FIG. 6 shows an example 600 of the robust accuracy of the described techniques for various weights.

In particular, FIG. 6 shows an example 600 of the l_{∞} robust accuracy on two image classification tasks (CIFAR-10 and ImageNet) of a “soup” that includes a combination of two instances of the neural network, one trained from scratch using the l_{∞}-norm attack (referred to in FIG. 6 as θ_{∞}) and the other fine-tuned on the l₂-norm attack starting from the trained values of the instance that was trained on the l_{∞}-norm attack (referred to in FIG. 6 as θ_{∞→2}).

In particular, the example 600 plots the weight w assigned to the values of the network parameters of the instance trained using the l_{∞}-norm attack, with the values of the network parameters of the instance trained using the l₂-norm attack being assigned a weight of (1-w). Thus, when w is equal to one, the soup consists only of the instance trained using the l_{∞}-norm attack, since the weight assigned to the instance trained using the l₂-norm attack is zero.

As can be seen from the example of FIG. 6, by appropriately selecting the weight w, the soup exceeds the performance of the instance trained from scratch using the l_{∞}-norm attack on both tasks in terms of being robust to the l_{∞}-norm attack. Thus, the inclusion of the other instance in the soup helps the soup be more robust to the l_{∞}-norm attack, even though the other instance is not trained to specifically counteract the l_{∞}-norm attack.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. Aspects of the disclosed subject matter may be as set out in the following numbered examples.

Example 1. A method of training a neural network having a plurality of network parameters to perform a target task, the method comprising:
obtaining data specifying a plurality of different adversarial training schemes, wherein each adversarial training scheme trains the neural network to be robust to a different type of adversarial attack;
for each of the plurality of adversarial training schemes:
   training an instance of the neural network on a respective set of training data for the target task using the adversarial training scheme to determine respective trained values for each of the plurality of network parameters; and
for each of the plurality of network parameters, generating a final value for the network parameter by combining the respective trained values for the network parameter for each of the plurality of adversarial training schemes.

Example 2. The method of example 1, wherein each adversarial training scheme has a corresponding loss function that is different from each other adversarial training scheme and wherein training an instance of the neural network on a respective set of training data for the target task using the adversarial training scheme to determine respective trained values for each of the plurality of network parameters comprises training the instance of the neural network on the loss function corresponding to the adversarial training scheme.

Example 3. The method of example 1 or example 2, wherein, for each of two or more of the adversarial training schemes, the type of adversarial attack for the adversarial training scheme is an/p-norm bounded attack for a corresponding value of p, and wherein each of the two or more of the adversarial training schemes have different corresponding values of p.

Example 4. The method of any one of example 1-3, wherein, for a first adversarial training scheme of the plurality of adversarial training schemes, training an instance of the neural network on a respective set of training data for the target task using the first adversarial training scheme to determine respective trained values for each of the plurality of network parameters comprises:
training the instance of the neural network on the respective set of training data for the target task using the first adversarial training scheme and starting from initial values of the network parameters to determine respective trained values for each of the plurality of network parameters.

Example 5. The method of example 4, wherein the initial values of the network parameters are determined using a random parameter initialization technique.

Example 6. The method of example 4, wherein the initial values of the network parameters are determined by pre-training the neural network.

Example 7. The method of any one of examples 4-6, wherein, for each of one or more second adversarial training scheme of the plurality of adversarial training schemes, training an instance of the neural network on a respective set of training data for the target task using the second adversarial training scheme to determine respective trained values for each of the plurality of network parameters comprises:
training the instance of the neural network on the respective set of training data for the target task using the second adversarial training scheme and starting from the respective trained values of the network parameters for the first adversarial training scheme to determine respective trained values for each of the plurality of network parameters.

Example 8. The method of example 7, wherein training the instance of the neural network on the respective set of training data for the target task using the second adversarial training scheme comprises training the instance of the neural network for (i) fewer training iterations, (ii) on fewer training examples, or both than were used in the training for the first adversarial training scheme.

Example 9. The method of any preceding example, further comprising:
determining a respective weight for each of the adversarial training schemes, wherein for each of the plurality of network parameters, generating a final value for the network parameter by combining the respective trained values for the network parameter for each of the plurality of adversarial training schemes comprises:
computing a weighted sum of the respective trained values for the network parameter for each of the plurality of adversarial training schemes in accordance with the respective weights for each of the adversarial training schemes.

Example 10. The method of example 9, wherein determining a respective weight for each of the adversarial training schemes comprises:
obtaining test data for the target task; and
determining, using the test data, the respective weights.

Example 11. The method of example 10, wherein a distribution of the network inputs in the test data differ from a distribution of network inputs in the respective sets of training data for the adversarial training schemes.

Example 12. The method of example 10 or example 11, wherein determining, using the test data, the respective weights comprises:
determining a plurality of candidate sets of weights;
for each of the plurality of candidate sets of weights:
   generating, using the candidate set of weights, respective candidate final parameter values for the network parameters; and
   determining a performance metric on the test data of an instance of the neural network having the candidate final parameter values; and selecting one of the candidate sets of weights based on the performance metrics.

Example 13. The method of example 12, wherein the performance metric measures an accuracy on the test data of the instance of the neural network having the candidate final parameter values.

Example 14. The method of example 12, wherein the performance metric measures a robustness of the instance of the neural network having the candidate final parameter values to one or more particular types of adversarial attack on network inputs in the test data.

Example 15. The method of example 14, wherein one or more of the particular types of adversarial attack are different from the type of adversarial attack for any of the plurality of adversarial training schemes.

Example 16. The method of any preceding example, wherein the target task is image classification, and wherein the neural network is configured to receive a network input comprising an image and to generate a network output comprising a respective score for each of a plurality of categories; or
wherein the target task is object detection, and wherein the neural network is configured to receive a network input comprising an image and to generate a network output comprising an identification of a position of an object within the image; or
wherein the target task is image segmentation, and wherein the neural network is configured to receive a network input comprising an image and to generate a network output comprising, for at least one pixel of the input image, a category from a set of possible categories that a scene depicted at the at least one pixel belongs to; or
wherein the target task is agent control, and wherein the neural network is configured to receive a network input comprising sensor data characterizing a state of an environment being interacted with by an agent, and to generate a network output comprising a control policy for controlling the agent.

Example 17. A method of configuring a neural network having a plurality of network parameters to perform a target task, the method comprising:
obtaining data specifying, for each of a plurality of different adversarial training schemes, respective trained values for each of the plurality of network parameters, wherein each adversarial training scheme trains the neural network to be robust to a different type of adversarial attack, and wherein the respective trained values for each of the plurality of network parameters for each adversarial training scheme have been determined by training an instance of the neural network on a respective set of training data for the target task using the adversarial training scheme;
obtaining test data for the target task;
determining, using the test data, a respective weight for each of the adversarial training schemes; and
for each of the plurality of network parameters, generating a final value for the network parameter by computing a weighted sum of the respective trained values for the network parameter for each of the plurality of adversarial training schemes in accordance with the respective weights for the adversarial training schemes.

Example 18. A method performed by one or more computers, the method comprising:
receiving a new network input; and
processing the new network input using a neural network in accordance with final values of a plurality of network parameters of the neural network to generate network output for a target task for the new network input, wherein the final values of the plurality of network parameters have been generated by performing the operations of the respective method of any preceding example.

Example 19. The method of example 18, wherein;
the new network input comprises an image and the network output comprises classification data, the classification data comprising a respective score for each of a plurality of categories; or
the new network input comprises an image and the network output comprises object detection data, the object detection data comprising an identification of a position of an object within the image; or
the new network input comprises an image and the network output comprises segmentation data, the segmentation data comprising, for at least one pixel of the input image, a category from a set of possible categories that a scene depicted at the at least one pixel belongs to; or
the new network input comprises sensor data characterizing a state of an environment being interacted with by an agent, and the network output comprises control policy data, the control policy data comprising a control policy for controlling the agent.

Example 20. A system comprising one or more computers and one or more storage devices storing instructions that when executed by the one or more computers cause the one or more computers to perform the operations of the method any one of examples 1 to 19.

Example 21. One or more computer storage media storing instructions that when executed by one or more computers cause the one or more computers to perform the operations of the method any one of examples 1 to 19.

1. A method of training a neural network having a plurality of network parameters to perform a target task, the method comprising:
obtaining data specifying a plurality of different adversarial training schemes, wherein each adversarial training scheme trains the neural network to be robust to a different type of adversarial attack;
for each of the plurality of adversarial training schemes:
training an instance of the neural network on a respective set of training data for the target task using the adversarial training scheme to determine respective trained values for each of the plurality of network parameters; and
for each of the plurality of network parameters, generating a final value for the network parameter by combining the respective trained values for the network parameter for each of the plurality of adversarial training schemes.

2. The method of claim 1, wherein each adversarial training scheme has a corresponding loss function that is different from each other adversarial training scheme and wherein training an instance of the neural network on a respective set of training data for the target task using the adversarial training scheme to determine respective trained values for each of the plurality of network parameters comprises training the instance of the neural network on the loss function corresponding to the adversarial training scheme.

3. The method of claim 1, wherein, for each of two or more of the adversarial training schemes, the type of adversarial attack for the adversarial training scheme is an lₚ-norm bounded attack for a corresponding value of p, and wherein each of the two or more of the adversarial training schemes have different corresponding values of p.

4. The method of claim 1, wherein, for a first adversarial training scheme of the plurality of adversarial training schemes, training an instance of the neural network on a respective set of training data for the target task using the first adversarial training scheme to determine respective trained values for each of the plurality of network parameters comprises:
training the instance of the neural network on the respective set of training data for the target task using the first adversarial training scheme and starting from initial values of the network parameters to determine respective trained values for each of the plurality of network parameters.

5. The method of claim 4, wherein the initial values of the network parameters are determined using a random parameter initialization technique.

6. The method of claim 4, wherein the initial values of the network parameters are determined by pre-training the neural network.

7. The method of claim 4, wherein, for each of one or more second adversarial training scheme of the plurality of adversarial training schemes, training an instance of the neural network on a respective set of training data for the target task using the second adversarial training scheme to determine respective trained values for each of the plurality of network parameters comprises:
training the instance of the neural network on the respective set of training data for the target task using the second adversarial training scheme and starting from the respective trained values of the network parameters for the first adversarial training scheme to determine respective trained values for each of the plurality of network parameters.

8. The method of claim 7, wherein training the instance of the neural network on the respective set of training data for the target task using the second adversarial training scheme comprises training the instance of the neural network for (i) fewer training iterations, (ii) on fewer training examples, or both than were used in the training for the first adversarial training scheme.

9. The method of claim 1, further comprising:
determining a respective weight for each of the adversarial training schemes, wherein for each of the plurality of network parameters, generating a final value for the network parameter by combining the respective trained values for the network parameter for each of the plurality of adversarial training schemes comprises:
computing a weighted sum of the respective trained values for the network parameter for each of the plurality of adversarial training schemes in accordance with the respective weights for each of the adversarial training schemes.

10. The method of claim 9, wherein determining a respective weight for each of the adversarial training schemes comprises:
obtaining test data for the target task; and
determining, using the test data, the respective weights.

11. The method of claim 10, wherein a distribution of the network inputs in the test data differ from a distribution of network inputs in the respective sets of training data for the adversarial training schemes.

12. The method of claim 10, wherein determining, using the test data, the respective weights comprises:
determining a plurality of candidate sets of weights;
for each of the plurality of candidate sets of weights:
generating, using the candidate set of weights, respective candidate final parameter values for the network parameters; and
determining a performance metric on the test data of an instance of the neural network having the candidate final parameter values; and
selecting one of the candidate sets of weights based on the performance metrics.

13. The method of claim 12, wherein the performance metric measures an accuracy on the test data of the instance of the neural network having the candidate final parameter values.

14. The method of claim 12, wherein the performance metric measures a robustness of the instance of the neural network having the candidate final parameter values to one or more particular types of adversarial attack on network inputs in the test data.

15. The method of claim 14, wherein one or more of the particular types of adversarial attack are different from the type of adversarial attack for any of the plurality of adversarial training schemes.

16. The method of claim 1, wherein the target task is image classification, and wherein the neural network is configured to receive a network input comprising an image and to generate a network output comprising a respective score for each of a plurality of categories; or
wherein the target task is object detection, and wherein the neural network is configured to receive a network input comprising an image and to generate a network output comprising an identification of a position of an object within the image; or
wherein the target task is image segmentation, and wherein the neural network is configured to receive a network input comprising an image and to generate a network output comprising, for at least one pixel of the input image, a category from a set of possible categories that a scene depicted at the at least one pixel belongs to; or
wherein the target task is agent control, and wherein the neural network is configured to receive a network input comprising sensor data characterizing a state of an environment being interacted with by an agent, and to generate a network output comprising a control policy for controlling the agent.

17. A method of configuring a neural network having a plurality of network parameters to perform a target task, the method comprising:
obtaining data specifying, for each of a plurality of different adversarial training schemes, respective trained values for each of the plurality of network parameters, wherein each adversarial training scheme trains the neural network to be robust to a different type of adversarial attack, and wherein the respective trained values for each of the plurality of network parameters for each adversarial training scheme have been determined by training an instance of the neural network on a respective set of training data for the target task using the adversarial training scheme;
obtaining test data for the target task;
determining, using the test data, a respective weight for each of the adversarial training schemes; and
for each of the plurality of network parameters, generating a final value for the network parameter by computing a weighted sum of the respective trained values for the network parameter for each of the plurality of adversarial training schemes in accordance with the respective weights for the adversarial training schemes.

18-21. (canceled)

22. A system comprising one or more computers and one or more storage devices storing instructions that when executed cause the one or more computers to perform operations for training a neural network having a plurality of network parameters to perform a target task, the operations comprising:
obtaining data specifying a plurality of different adversarial training schemes, wherein each adversarial training scheme trains the neural network to be robust to a different type of adversarial attack;
for each of the plurality of adversarial training schemes:
training an instance of the neural network on a respective set of training data for the target task using the adversarial training scheme to determine respective trained values for each of the plurality of network parameters; and
for each of the plurality of network parameters, generating a final value for the network parameter by combining the respective trained values for the network parameter for each of the plurality of adversarial training schemes.

23. The system of claim 22, wherein each adversarial training scheme has a corresponding loss function that is different from each other adversarial training scheme and wherein training an instance of the neural network on a respective set of training data for the target task using the adversarial training scheme to determine respective trained values for each of the plurality of network parameters comprises training the instance of the neural network on the loss function corresponding to the adversarial training scheme.

24. The system of claim 22, wherein, for each of two or more of the adversarial training schemes, the type of adversarial attack for the adversarial training scheme is an/p-norm bounded attack for a corresponding value of p, and wherein each of the two or more of the adversarial training schemes have different corresponding values of p.
